(19) United States
(12) Patent Application Publication
(10) Pub. No.: US 2004/0232379 A1
(43) Pub. Date: Nov. 25, 2004

(54) Multi-oxidizer-based slurry for nickel hard disk planarization

(76) Inventors: Joseph G. Ameen, Newark, DE (US); Zhendong Liu, Newark, DE (US); John Quanci, Haddonfield, NJ (US)

Correspondence Address: Rodel Holdings, Inc., Suite 1300, 1105 North Market Street, Wilmington, DE, 19899, US

(21) Appl. No.: 10/652,177

(22) Filed: Aug. 29, 2003

Related U.S. Application Data
(63) Continuation-in-part of application No. 10/442,293, filed on May 20, 2003, now abandoned.

(51) Int. Cl. A01N 1/00; C01B 11/00

(52) U.S. Cl. 252/186.1

(57) ABSTRACT

A slurry composition for planarizing nickel or nickel-alloy coating on substrates, such as a nickel coating on a memory hard disk, includes at least two oxidizers, an abrasive, water, and no metal catalyst. The composition is effective for polishing nickel (Ni) and nickel alloys coatings formed in the manufacture of memory disks.

This is a Continuation-In-Part application of U.S. patent application Ser. No.10/442,293 filed May 20, 2003, now abandoned.

### BACKGROUND OF THE INVENTION

The present invention relates to the planarization, and in particular relates to slurries containing oxidizers for planarizing a coating such as nickel-based coatings used in applications, such as, the manufacture of memory hard disks.

Most modem-day computers have a magnetic memory disk (“hard disk”) for storing and retrieving a variety of information. The memory disks are rigid and typically made from an aluminum alloy substrate with a nickel (Ni) or nickel alloys such as nickel-phosphorous (Ni—P) coating layer. The coating layer is formed by electroplating and typically has a rough surface. The coating layer thus needs to be polished or “planarized” before the active magnetic surface coating is applied.

The preferred method of planarizing the Ni or nickel alloys such as Ni—P coating is chemical-mechanical planarization or “CMP”. In CMP, slurry compositions are used to both etch and polish a metal surface. The slurries typically include abrasive particles in an aqueous medium containing reactive chemicals.

Competing chemical reactions typically take place during CMP. The first of these is an oxidation reaction. During oxidation, an oxidizing agent (oxidizer) acts to form a metallic oxide with the surface of the substrate. The second reaction is a complexing or dissolution reaction. In this reaction, a complexing agent, or an acid or base, actively dissolves the oxide film growing on the substrate as a result of the oxidation reaction.

Most of the current commercially available slurries used for Ni and Ni—P planarization include a combination of an abrasive agent, an oxidizer and a metal catalyst. The latter enhances the oxidizer performance to achieve a high removal rate during planarization. Commonly known oxidizers, or oxidizing agents, include hydrogen peroxide, potassium ferrocyanide, potassium dichromate, vanadium trioxide, hypochlorous acid, sodium hypochlorite, potassium hypochlorite, calcium hypochlorite, ferric nitrate, ammonium persulfate, ammonium nitrate, potassium nitrate, potassium permanganate, ammonium hydroxide and combinations thereof. The oxidizer engages in a reduction-oxidation chemical reaction with the metal being polished to form an oxide layer on the metal surface.

U.S. Pat. No. 6,015,506 to Streinz et al. discloses a method of polishing a rigid disk, wherein the method includes providing a metal oxide abrasive, at least one oxidizing agent, and at least one catalyst having multiple oxidation states. However, the metal catalyst contributes to the decomposition of the oxidizer, making the slurry pot life very short. Also, the material removal rate depends on the presence of the metal catalyst.

It would be useful therefore to find other compositions that have a longer pot life and that can provide reasonably high removal rates that are not limited by the presence of a metal catalyst.

### STATEMENT OF THE INVENTION

One aspect of the invention is a composition for planarizing a nickel or nickel alloy coating on substrates such as rigid memory disks. The composition includes a first oxidizer comprising a monopersulfate, and a second oxidizer selected from the group of oxidizers consisting of: hydrogen peroxide, peracetic acid, halogenates, and any combination thereof. The composition includes no metal catalyst.

Another aspect of the invention is a slurry composition for planarizing a nickel or nickel alloy coated substrate. The slurry composition includes between about 0.5 and 4 weight percent monopersulfate, and between about 0.1 and 3 weight percent hydrogen peroxide, and a pH of between 2 and 4. The slurry includes no metal catalysts.

Another aspect of the invention is a composition for planarizing a nickel or nickel alloy coated substrate. The composition includes water, an abrasive, a pH-adjusting agent in sufficient amounts to provide a pH between 1 and 5, a first oxidizing agent comprising a monopersulfate, and a second oxidizing agent selected from the group of oxidizing agents consisting of: hydrogen peroxide, peracetic acid, halogenates, and any combination thereof. The oxidizing agents are between about 0.1 and about 10 weight percent of the total weight of the composition. The composition also includes no metal catalyst.

Another aspect of the invention is a method of planarizing a nickel or nickel alloy substrate, such as a rigid disk substrate, having a Ni or Ni alloy such as Ni—P coatings. The method includes forming a slurry by combining: i) at least first and second oxidizing agents, wherein the first oxidizing agent includes a monopersulfate and the second oxidizing agent includes as least one of hydrogen peroxide, peracetic acid, halogenates, ii) at least one abrasive, iii) deionized water, and iv) no metal catalyst. The method further includes applying the slurry to the substrate, and removing at least a portion of the Ni or Ni alloy such as a Ni—P coating from the substrate by bringing a pad, such as polishing pad, into contact with the substrate and moving the pad in relation to the substrate in the presence of the slurry.

### DETAILED DESCRIPTION OF THE INVENTION

The present invention is a slurry for planarizing coatings on substrates, especially metal coatings having Ni, such as those used on memory hard disks, that includes a combination of at least two oxidizers and no metal catalyst. It has been discovered that slurries having a combination of certain oxidizers have greater removal rates than possible with just a single oxidizer. Thus, selectively combining two or more oxidizers in the manner described below obviates the need for adding a performance-enhancing metal catalyst to the slurry. Note, although the invention will be described in regards to Ni and Ni-alloy coatings (e.g., Ni—P) on memory hard disks, the invention is not so limited. Rather, the present invention is fully intended to be equally applicable to any other application wherein a nickel or nickel-alloy, that is formed on a substrate, is desired to be planarized. For example, the present invention can be utilized in, for example, an integrated circuit application wherein the conductive plugs in an interconnect system are formed by Ni alloy, for example, Ni—P.

Oxidizers suitable for use in the present invention include those selected from the group of oxidizers comprising: monopersulfate salts, hydrogen peroxide, peracetic acid, chromates, halogenates, and combinations thereof. One well-known class of monopersulfates is known as a “triple salt,” and includes KHSO₅, KHSO₄ and K₂SO₄. Preferably, at least one oxidizer is a triple salt, referred to as a monopersulfate salt. One commonly known monopersulfate salt is known by the tradename Oxone® triple salt, available from DuPont, Wilmington, Del. As used herein, the terms “monopersulfates” and “monopersulfate salts” are used interchangeably to refer to the same class of oxidizers.

In the present invention, at least one of the oxidizers is a peroxy compound, preferably hydrogen peroxide. The halogenates are selected from bromate and iodates, more preferably bromates. The at least two oxidizers include monopersulfate salts and hydrogen peroxide.

In an example embodiment, the concentrations of the combined oxidizers range from 0.1% to 10% of the total weight of the slurry composition. In another example embodiment, the combined oxidizers are less than 6 wt % of the slurry. Preferably, at least one oxidizer is a monopersulfate salt present in an amount between 0.1 wt % and 6 wt %, preferably in an amount between 0.5 wt % and 3 wt %, more preferably between 1 wt % and 2 wt %.

Further in the example embodiment, at least one oxidizer is hydrogen peroxide, present in an amount between 0.1 wt % and 6 wt %, preferably in an amount between 0.3 wt % and 3 wt %, more preferably between 0.5 wt % and 1.5 wt %.

Generally, it has been found that increased amounts of oxidizers do not proportionately increase the removal rate. Rather, there is a diminishing rate of return for increased use of oxidizers that must be balanced with the increased cost of the oxidizer versus the decreased cost for polishing associated with the increased removal rate. In an example embodiment, optimal amounts of oxidizers for a particular planarization application are determined empirically.

In an example embodiment, an abrasive agent may also be added to the slurry to mechanically remove the oxide layer during CMP. Any abrasive known to be useful for CMP applications may be used with the present invention, including newer abrasives such as polymer coated abrasive particles. For example, silica, alumina, silicon carbide, silicon nitride, iron oxide, ceria, and combinations thereof are suitable for use in the present invention. More specifically, the colloidal silica abrasive slurry known under the tradename Nalco 2360, manufactured by Ondeo-Nalco Co., of Naperville, Ill., is a suitable abrasive slurry for forming the slurry of the present invention. Nalco 2360 has an average particle size around 60 nm and a pH of about 4.0.

In another example embodiment of the invention, the slurry optionally includes a complexing agent. For example, the complexing agent may be a carboxylic acid, multi-carboxylic acid, hydroxy-carboxylic acid, multi-hydroxy carboxylic acid, aminocarboxylic acid or a polymeric carboxylic acid, which chemically removes the oxide layer from the substrate. Further, the complexing agent is selected from the group comprising, malic acid, malonic acid, lactic acid, citric acid, sulfosalicylic acid, formic acid, aminodiacetic acid, glycine, ethylenediaminetetraacetic acid, polyacrylic acid and polymaleic acid, and mixtures thereof. In an example embodiment, the complexing agent concentration is between about 0.1 wt % and about 3 wt %.

The slurry compositions according to the present invention preferably have an acidic pH. In a preferred embodiment, the composition has an acidic pH greater than about 1. More preferably, the pH is between about 2 and about 5, more preferably less than about 4, and most preferably between 2 and 3. The pH of the slurry is measured by conventional methods after mixing the ingredients. The pH can be adjusted by adding a base, such as sodium hydroxide (NaOH), or a mineral acid, such as nitric acid (HNO₃).

The above-stated preferred ingredients and combinations apply to each of the preferred embodiments of the invention described below. One preferred embodiment of the invention is a composition for planarizing a nickel or nickel alloy substrate, wherein the composition includes a combination of two oxidizers. The first oxidizer includes a monopersulfate salt, and the second oxidizer is selected from the group of oxidizers consisting of: hydrogen peroxide, peracetic acid and halogenates.

A second preferred embodiment of the invention is a slurry composition for planarizing a nickel or nickel alloy substrate, such as rigid memory disks. The slurry composition comprises a combination of oxidizers that includes between about 0.5 and 4 weight percent monopersulfate salts and between about 0.1 and 3 weight percent hydrogen peroxide. The slurry composition has a pH of between 2 and 4.

A third preferred embodiment of the invention is a composition for planarizing a nickel or nickel alloy substrate, such as rigid memory disks in the absence of a metal catalyst. The composition comprises water, an abrasive, a pH-adjusting agent in sufficient amounts to provide a pH between 1 and 5, an optional complexing agent, and at least first and second oxidizing agents. The first oxidizing agent includes monopersulfate and the second oxidizing agent is selected from the group of oxidizing agents consisting of: hydrogen peroxide, peracetic acid and halogenates. The first and second oxidizing agents are present in the total amount of between about 0.1 and about 10 weight percent by weight of the total weight of the slurry composition.

A fourth preferred embodiment of the invention is a method for polishing a substrate, such as a rigid disk substrate, to remove at least a portion of a metal coating, such as at least a portion of a Ni or a nickel alloy such as Ni—P coatings. The method includes forming a composition by combining at least two oxidizing agents. The first oxidizing agent includes monopersulfate, and the second oxidizing agent is selected from the group of oxidizing agents consisting of: hydrogen peroxide, peracetic acid and halogenates. Forming the composition further includes adding at least one abrasive, and deionized water to provide a CMP composition free of metal catalyst. The method further includes applying the CMP composition to the substrate, and removing at least a portion of the Ni or nickel alloy such as Ni—P layer from the substrate by bringing a polishing pad into contact with the substrate and moving the pad in relation to the substrate in the presence of the slurry.

The slurry compositions in accordance with the invention may be manufactured and shipped in a ready-to-use condition, or may be prepared on site by the memory hard disk manufacturer in the manner described above. Optionally, complexing agents and stabilizers may also be included, and may optionally be pre-mixed and shipped with the oxidizing agents. The slurry composition may then be applied to the memory hard disk surface while it is set in a polishing machine.

The method of the invention may be performed on any suitable chemical mechanical polishing machine, such as Model 6EC system manufactured by Strasbaugh, Inc. of San Luis Obispo, Calif. A rigid memory disk may be attached to a carrier and held in proximity to a polishing pad, which in turn is held on an opposing platen. The polishing slurry made in accordance with the present invention is allowed to freely flow between the disk and the polishing pad. The disk is rotated about its axis. The polishing pad undergoes planetary motion centered at the axis of rotation of the platen. The disk platen provides a means by which pressure is applied to the backside of the disk to allow for fine control of the pressure by which the disk is held against the polishing pad. A suitable polishing pad, such as DPM 2000 supplied by Rodel, Inc. of Newark, Del., can be utilized.

### EXAMPLES

### Experimental Procedures

Slurries were prepared by mixing appropriate amounts of chemicals and abrasive particles in a 5-gallon bucket. The pH was adjusted by adding sufficient amounts of 70% HN₀₃ and 10N NaOH to obtain the desired pH. Hydrogen peroxide (30%) was purchased from Ashland Chemical Co., of Dublin, Ohio. Oxone® triple salt (potassium peroxymonosulfate; molecular formula: 2KHSO₅KHSO₄K₂SO₄) and the other chemicals were obtained from Sigma-Aldrich Corp., of St. Louis, Mo. Nalco 2360 was used as the abrasive particles.

Rigid memory hard disks were obtained for experimental polishing. The disks were aluminum substrate deposited electrolessly with nickel-phosphorus manufactured by Komag Inc., San Jose, Calif.

Planarization experiments were conducted on a model 6EC, single-sided polishing machine manufactured by Strasbaugh, Inc., of San Luis Obispo, Calif. A polishing pad, Model DPM 2000, manufactured by Rodel Inc., Newark, Del., was used on the polishing machine. The polishing parameters are listed below:

Polishing temperature: 20° C.

Polishing pressure: 2 psi

Polishing time: 6 minutes

Slurry flow rate: 100ml/min

Rotating speed (table/carrier): 25/75 rpm

After polishing, the disks were spin-dried by a disk cleaner, Model 100, manufactured by Exclusive Design Co., San Jose, Calif., and the disk weight was measured. The removal in 6-minute polishing was calculated by subtracting the weight after polishing from the weight before polishing.

Experimental data

A series of studies following the experimental procedures outlined above were conducted to determine the relative performance of a combination of oxidizers relative to single oxidizers in catalyst-free slurry compositions. The weight percent of the composition is expressed in absolute percentage based on the total weight of the aqueous slurry.

Study 1

Following the experimental procedures described above, a comparison test was performed using a slurry composition containing 7 wt % abrasive and oxidizing agents including monopersulfate alone or in combination with one of hydrogen peroxide, sodium persulfate or potassium bromate. Also, a comparative slurry composition, as shown below as slurry No. 8 was prepared combining three oxidizers: monopersulfate, sodium persulfate, and potassium bromate. The results of this study are shown below in Table 1. The combination of sodium persulfate with any of the other oxidizing agents appeared to exhibit a negative effect on the removal rate of the nickel phosphorus coating. Increasing the amount of sodium persulfate, as shown for slurry No. 3, had a reduction in the coating removal rate. Likewise, the addition of sodium persulfate to the combination of monosulfate and potassium bromate, as in slurry No. 8, also showed a reduction in the removal rate of the coating. In comparison with slurry No. 1, which includes only single oxidizing agent of monopersulfate, the addition of potassium bromate as shown in slurry No. 7 showed an enhanced removal rate. Likewise, the combination of monopersulfate and hydrogen peroxide, as in slurry No. 4, appeared to exhibit an even greater enhanced removal rate. As can be seen in the results from slurry Nos. 5 and 6, the increased amounts of hydrogen peroxide added to the monopersulfate appears to have a peak enhancement to the effective removal rate such that amounts of hydrogen peroxide added in amounts greater that the amount of monopersulfate did not have any significant increased enhanced effect on the removal rate.

TABLE 1

| | | Wt. % | | | | | |
|---|---|---|---|---|---|---|---|
| | Wt. % of | of Oxone | Wt. % of | Wt. % of | Wt. % of | | Removal in 6 |
| Slurry | Nalco 2360 | triple salt | H₂O₂ | Na₂S₂O₈ | KBrO₃ | pH | minutes, g |
| 1 | 7 | 1.5 | 0 | 0 | 0 | 2.3 | 0.04948 |
| 2 | 7 | 1.5 | 0 | 1 | 0 | 2.3 | 0.04863 |
| 3 | 7 | 1.5 | 0 | 2 | 0 | 2.3 | 0.04773 |
| 4 | 7 | 1.5 | 0.6 | 0 | 0 | 2.3 | 0.05887 |
| 5 | 7 | 1.5 | 1.5 | 0 | 0 | 2.3 | 0.06140 |
| 6 | 7 | 1.5 | 2.4 | 0 | 0 | 2.3 | 0.06127 |
| 7 | 7 | 1.5 | 0 | 0 | 2 | 2.3 | 0.05461 |
| 8 | 7 | 1.5 | 0 | 1 | 2 | 2.3 | 0.05017 |

Study 2

Study 2 provides a comparative test of using potassium bromate as a single oxidizing agent in the slurry composition shown in Table 2. The comparison of the results from slurry No. 9, below, with the results from slurry No. 7, above, indicates that the combination of monopersulfate and potassium bromate has an enhanced removal rate compared to the use of either oxidizing agent alone.

TABLE 2

| | Wt. % of | Wt. % of | | Removal in 6 |
|---|---|---|---|---|
| Slurry | Nalco 2360 | KBrO₃ | pH | minutes, g |
| 9 | 7 | 2 | 2.3 | 0.04147 |

Study 3

This study provides a comparison of the effect that the pH of the slurry composition has on the removal rate. The results of slurry composition No. 10, shown in Table 3, below, in comparison to slurry compositions Nos. 4 and 5, above, indicate that using a combination of monopersulfate and hydrogen peroxide as a slurry composition performs better at lower pH levels. Operating at a pH of 2.3 appears to have a marked increase in the removal rate compared to a slightly less acidic slurry composition at a pH of 3.5.

TABLE 3

| | | Wt. % of | | | |
|---|---|---|---|---|---|
| | Wt. % of Nalco | Oxone triple | Wt. % of | | Removal in 6 |
| Slurry | 2360 | salt | H₂O₂ | pH | minutes, g |
| 10 | 7 | 1.5 | 0.9 | 3.5 | 0.03177 |

Study 4

This study provides comparison data for the combination of monopersulfate with a peroxy radical oxidizing agent other than hydrogen peroxide. As shown in Table 4, below, Slurry No. 11 includes the combination of Oxone® triple salt and peracetic acid. In comparison, the combination of peracetic acid with Oxone® triple salt does not work as well as the combination of hydrogen peroxide with Oxone® triple salt in the same concentration and at the same pH, as shown above for Slurry No. 5.

TABLE 4

| | | Wt. % of | Wt. % of | | |
|---|---|---|---|---|---|
| | Wt. % of | Oxone triple | peracetic | | Removal in 6 |
| Slurry | Nalco 2360 | salt | acid | pH | minutes, g |
| 11 | 7 | 1.5 | 1.05 | 2.3 | 0.04955 |

Study 5

This study shows the effect of a slurry composition containing two oxidizing agents consisting of hydrogen peroxide and potassium chromate, as shown in Table 5, below. The substitution of potassium chromate for monopersulfate appears to have a negative effect on the coating removal rate.

TABLE 5

| | Wt. % of | Wt. % of | Wt. % of | | Removal in 6 |
|---|---|---|---|---|---|
| Slurry | Nalco 2360 | H₂O₂ | KCrO₄ | pH | minutes, g |
| 12 | 7 | 0.9 | 1 | 2.3 | 0.0224 |

Study 6

This study shows the effect on varying the concentration of monopersulfate in combination with hydrogen peroxide. As shown in Table 6, below, comparing Slurry Nos. 13 and 14, the use of hydrogen peroxide as a single oxidizing agent exhibits a slightly superior performance over the use of sodium persulfate as a single oxidizing agent. However, as shown below in Table 6, the use of increasing amounts of monopersulfate in combination with hydrogen peroxide has a significant effect on enhancing the removal rate of the nickel phosphorus coating in the rigid disk. As shown as slurry composition No. 16, when combined with about 1.5 wt % hydrogen peroxide, the amount of monopersulfate that appears to maximize the enhanced effect of the removal rate is about 2 wt % Oxone® triple salt. Increasing the amount of monopersulfate above this concentration did not appear to have any significant enhancement on the removal rate of the surface coating.

In comparing the results of Study No. 1 with the results of Study No. 6, it appears that the enhanced effects of combining monopersulfate and hydrogen peroxide are maximized by using a weight percent ratio of monopersulfate to a weight percent of hydrogen peroxide that is approximately 1:1. Although enhanced effects are noticeable upon addition of small amounts of a second oxidizer, increasing the amount of the second oxidizer in excess of the first oxidizer appears to have marginally diminishing benefit. In Study No. 1, maximal results were achieved with Slurry No. 5 that had a ratio of 1:1. In Study No. 6, maximal results were achieved with Slurry No. 16 that had a ratio of 2:1.5 (or 1.33:1). In other words, using an amount of one of the oxidizing agents in great excess of the concentration of the other oxidizing agent appears to have no significant enhanced effects on the removal rate.

TABLE 6

| | | Wt. % of | | | | |
|---|---|---|---|---|---|---|
| | Wt. % of | Oxone triple | Wt. % of | Wt. % of Sodium | | Removal in 6 |
| Slurry | Nalco 2360 | salt | H₂O₂ | persulfate | pH | minutes, g |
| 13 | 7 | 0 | 0 | 1.5 | 2.3 | 0.032 |
| 14 | 7 | 0 | 1.5 | 0 | 2.3 | 0.03415 |
| 15 | 7 | 1 | 1.5 | 0 | 2.3 | 0.04250 |
| 16 | 7 | 2 | 1.5 | 0 | 2.3 | 0.05680 |
| 17 | 7 | 3 | 1.5 | 0 | 2.3 | 0.05545 |
| 18 | 7 | 4 | 1.5 | 0 | 2.3 | 0.05585 |

Study 7

In this study, it is shown that the use of monopersulfate in combination with hydrogen peroxide has a greater than additive effect on the removal rate of nickel phosphorus coating. As shown below in Table 7, for slurry compositions Nos. 19 and 20, when using hydrogen peroxide as a single oxidizing agent, doubling the concentration of hydrogen peroxide from 0.025 molar to 0.05 molar has only a slight increase in the removal rate. Likewise, as shown with slurry compositions Nos. 21 and 22, doubling the molar concentration of monopersulfate from 0.025 molar to 0.05 molar also has a very slight increase in the removal rate. In contrast, as shown with slurry No. 23, when using the same total molar concentration of 0.05 molar oxidizing agents but using combinations of monopersulfate at 0.025 molar and hydrogen peroxide at 0.025 molar, the removal rate is greatly enhanced and unexpectedly superior than what would be expected based on the removal rates of either oxidizing agents alone or based on the increased effect of increased amounts of either oxidizing agent used alone. This study shows that one can use lower amounts of total oxidizing agents by using a combination of monopersulfate and hydrogen peroxide in lower concentrations and yet achieve superior results from this combination of oxidizing agents.

TABLE 7

| | Wt. % of | Oxone triple salt | | H₂O₂ | | | Removal in 6 |
|---|---|---|---|---|---|---|---|
| Slurry | Nalco 2360 | Wt. % | Molar | Wt. % | Molar | pH | minutes, g |
| 19 | 7 | 0 | 0 | 0.085 | 0.025 | 2.3 | 0.04243 |
| 20 | 7 | 0 | 0 | 0.17 | 0.05 | 2.3 | 0.04367 |
| 21 | 7 | 1.54 | 0.025 | 0 | 0 | 2.3 | 0.04675 |
| 22 | 7 | 3.08 | 0.05 | 0 | 0 | 2.3 | 0.04713 |
| 23 | 7 | 1.54 | 0.025 | 0.085 | 0.025 | 2.3 | 0.05367 |

1. A composition for planarizing nickel or nickel-alloy coating on substrates, the composition comprising:
a first oxidizer comprising monopersulfate;
a second oxidizer selected from the group of oxidizers consisting of: hydrogen peroxide, peracetic acid, halogenates, and any combination thereof; and
no metal catalyst.

2. The composition of claim 1, further including a complexing agent.

3. The composition of claim 2, wherein the complexing agent concentration is between 0.1 wt % and 3 wt %.

4. The composition of claim 1, wherein the total amount of the first and second oxidizers combined is between 0.1% and 10% by weight of the total weight of the composition in a slurry form.

5. The composition of claim 1, wherein:
the second oxidizer is hydrogen peroxide present in an amount between about 0.1 and 3 weight percent of the total weight of the composition in a slurry form; and
the monopersulfate is present in an amount between 0.5 and 4 weight percent of the total weight of the composition in a slurry form.

6. The composition of claim 1, wherein the nickel or nickel-alloy coating is a conductive plug in an interconnect system of a semiconductor device.

7. A slurry composition for planarizing nickel or nickel-alloy coating on substrates, the slurry composition comprising:
between 0.5 and 4 weight percent monopersulfate; and
between 0.1 and 3 weight percent hydrogen peroxide;
no metal catalysts; and
a pH of between 2 and 4.

8. A composition for planarizing nickel or nickel-alloy coating on substrates, comprising:
water;
an abrasive;
a pH-adjusting agent in sufficient amounts to provide a pH between 1 and 5;
a first oxidizing agent comprising a monopersulfate;
a second oxidizing agent selected from the group of oxidizing agents consisting of: hydrogen peroxide, peracetic acid, halogenates, and any combination thereof;
wherein the oxidizing agents are 0.1 and 10 weight percent of the total weight of the composition; and
no metal catalyst.

9. The composition of claim 8, further comprising a complexing agent at a concentration between 0.1 wt % and 3 wt %.

10. (Canceled)
